(19) United States
(12) Patent Application Publication
(10) Pub. No.: US 2009/0230635 A1
(43) Pub. Date: Sep. 17, 2009

(54) LOCATING MEANS

(75) Inventors: Philip Bunce, Victoria (AU); Douglas Sims, West Perth (AU)

Correspondence Address: MERCHANT & GOULD PC, P.O. BOX 2903, MINNEAPOLIS, MN, 55402-0903, US

(73) Assignee: Eastland Medical Systems Ltd., West Perth (AU)

(21) Appl. No.: 11/813,320

(22) PCT Filed: Jan. 9, 2006
(86) PCT No.: PCT/AU2006/000019

§ 371 Date: Sep. 2, 2008

(30) Foreign Application Priority Data
Jan. 7, 2005 (AU) 2005900060

(51) Int. Cl. B23B 31/10; B23Q 3/12; B23B 31/107

(52) U.S. Cl. 279/17; 279/28; 279/111

(57) ABSTRACT

A locating means (13) adapted to be supported from one element (11) for engagement with another element to retain the two elements in engagement with each other, the locating means comprising a lug (39) to be displaceable between an extended position at which it extends from the locating means and a retracted position at which it is located inward of the extended position, a driving member (29) slidably supported from the one element the lug and driver having at least two opposed faces, the other element having an abutment which is intended in use to be engaged by the lug when the lug is in the extended position and the two elements are in engagement with each other in order to retain the elements in said engagement with each other, the opposed faces being configured such that movement of the driving member relative to the lug causes the displacement of the lug. A supporting arrangement to support a rotary gig which is adapted to support at least one work-piece from a drive head (11) to enable machining of the work-piece in which the supporting arrangement utilises the locating means is also claimed.

### FIELD OF THE INVENTION

This invention relates to a locating means which can be utilised between two members to ensure positive interengagement between two members and to prevent inadvertent disengagement between members.

A particular application of the embodiment comprises a locating means to lock jigs of the from disclosed on Australian provisional patent application 2005900055 International patent applications PCT/AU2004/000090 and PCT/AU2005/000432 and the mounting of jigs to a work head or of a form as disclosed in PCT/AU2005/000433 and PCT/AU2005/000429. The contents of each of the specifications are incorporated into the scope of this specification by reference thereto.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

According to one aspect the invention resides in A locating means adapted to be supported from one element for engagement with another element to retain the two elements in engagement with each other, the locating means comprising a lug to be displaceable between an extended position at which it extends from the locating means and a retracted position at which it is located inward of the extended position, a driving member slidably supported from the one element the lug and driver having at least two opposed faces, the other element having an abutment which is intended in use to be engaged by the lug when the lug is in the extended position and the two elements are in engagement with each other in order to retain the elements in said engagement with each other, the opposed faces being configured such that movement of the driving member relative to the lug causes the displacement of the lug.

According to a further aspect the invention resides in a supporting arrangement to support a rotary gig which is adapted to support at least one work-piece from a drive head to enable machining of the work-piece wherein at least one locating means of the form described above is supported form the drive head shaft to retain the two elements in engagement with each other and wherein the locating means is of the form as described above and is intended in use to engage with and support the rotary jig from the drive head.

According to a preferred feature of the invention the one element comprises an elongate member and the lug is movable away from the elongate member in its movement to the extended position, the elongate member in use to be received within an aperture provided in the other member whereby the abutment surface of the other member comprises a surface axially inward of the aperture which extends laterally from the edge of the opening.

According to a preferred feature of the invention the aperture has a configuration which is complementary to the cross-section of the elongate member.

According to a preferred feature of the invention the lug is slidably supported within the elongate body for slidable movement relative to the elongate body along an axis which is substantially transverse to the elongate body.

According to a preferred feature of the invention the driving member is slidably supported by the elongate body to be movable relative to the elongate body along an axis which is substantially parallel or coincidental with the central axis of the elongate body.

According to a preferred feature of the invention the lug is formed with a generally transverse passage and the driving member is formed with a shank portion which is slidably received in the transverse passage, said transverse passage having the opposed faces and the shank portion having the supporting surfaces, the opposed faces and the supporting faces being oblique to the central axes of the lug and the elongate member and to the direction of relative movement of the lug and the driving member in the elongate member.

According to a preferred feature of the invention one end of the driving member extends from the elongate member and is adapted to be engagable to cause the displacement of the driving member relative to the elongate member.

According to a preferred feature of the invention the driving member is biased to cause the lug to occupy its extended position.

A supporting arrangement as claimed at claim 10 wherein the one element comprises an elongate member and the lug is movable away from the elongate member in its movement to the extended position, the elongate member in use to be received within an aperture provided in the other member whereby the abutment surface of the other member comprises a surface axially inward of the aperture which extends laterally from the edge of the opening.

A supporting arrangement as claimed at claim 11 wherein aperture has a configuration which is complementary to the cross-section of the elongate member.

A supporting arrangement as claimed at claim 11 or 12 wherein the lug is slidably supported within the elongate body for slidable movement relative to the elongate body along an axis which is substantially transverse to the elongate body.

A supporting arrangement as claimed at claim 13 wherein the driving member is slidably supported by the elongate body to be movable relative to the elongate body along an axis which is substantially parallel or coincidental with the central axis of the elongate body.

A supporting arrangement as claimed at claim 14 wherein the lug is formed with a generally transverse passage and the driving member is formed with a shank portion which is slidably received in the transverse passage, said transverse passage having the opposed faces and the shank portion having the supporting surfaces, the opposed faces and the supporting faces being oblique to the central axes of the lug and the elongate member and to the direction of relative movement of the lug and the driving member in the elongate member.

A supporting arrangement as claimed at claim 15 wherein one end of the driving member extends from the elongate member and is adapted to be engagable to cause the displacement of the driving member relative to the elongate member.

A supporting arrangement as claimed at any one of claims 11 to 16 wherein the driving member is biased to cause the lug to occupy its extended position.

The invention will be more fully understood in the light of the following description of one specific embodiment.

### BRIEF DESCRIPTION OF THE DRAWINGS

The description is made with reference to the accompanying drawings of which:

FIG. 1 is a schematic isometric view of a drive head which is intended to receive a jig (not shown) and support the jig by locating means according to the first embodiment;

FIG. 2 is a side elevation of the locating means according to the first embodiment;

FIG. 3 is an outer end view of the locating means of FIG. 2;

FIG. 4 is another side elevation of the locating means of FIG. 2;

FIG. 4 is a sectional side elevation of the locating means of FIG. 2; and

FIG. 6 is an exploded view of the embodiment.

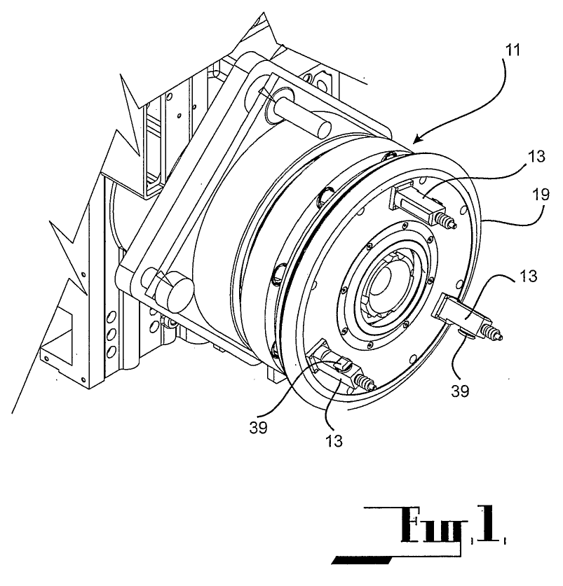

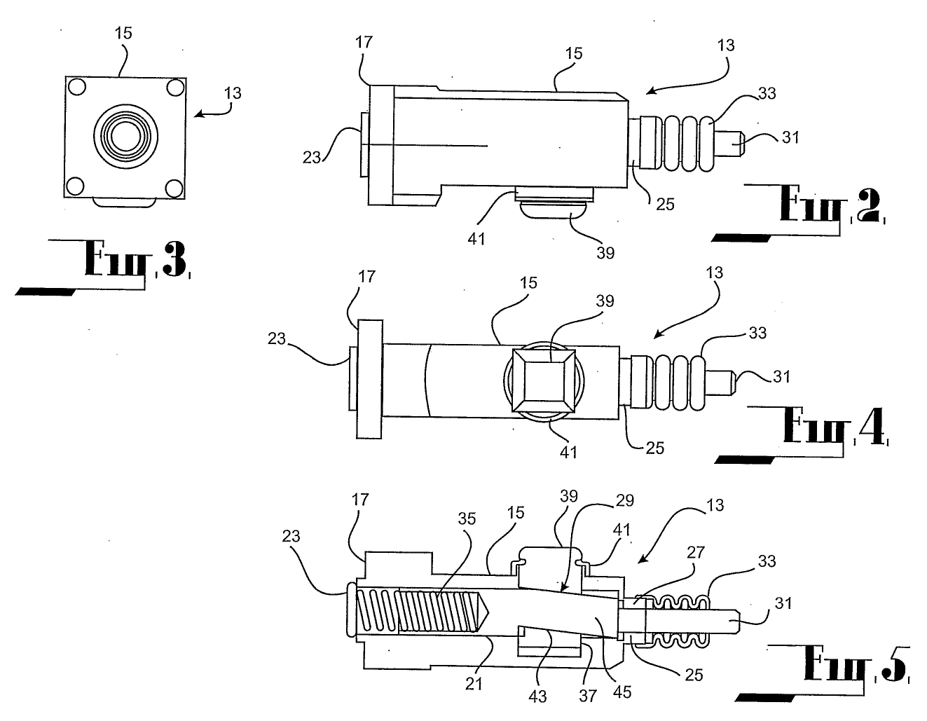

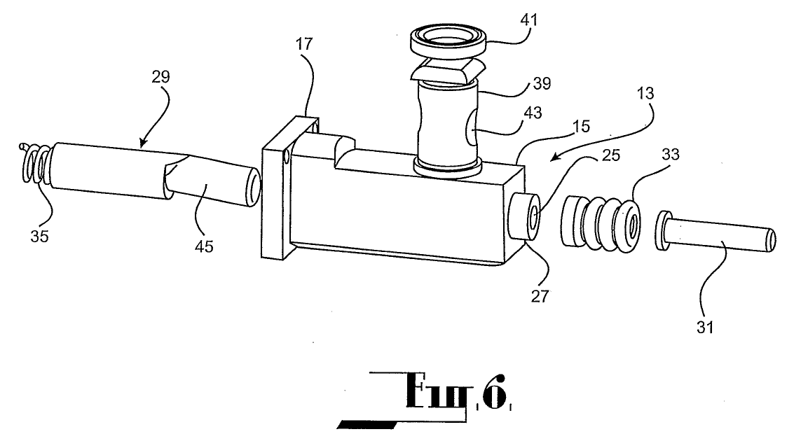

### DETAILED DESCRIPTION OF SPECIFIC EMBODIMENT

The first embodiment is directed towards a locating means which is intended to positively receive and support a jig (not shown) upon the drive head 11 of a milling machine wherein the jig is intended to support at least one work-piece which is to be subjected to a milling or machining action. As shown a set of the locating means according to the embodiment are supported from the drive head and are intended to engage and support the jig from the drive head such that there is no or minimal relative movement between the jig and the drive head. The locating means 13 according to the embodiment are intended to be received within a set of apertures provided on the opposed face of the jig.

The locating means comprise an elongate body 15 which is of a generally square cross section having an inner end which is intended to be mounted to the base plate 19 of the of the drive head 11 where the body 15 extends perpendicularly from the drive head. The body is formed with a substantially central longitudinal passage 21 which extends for substantially the full length of the body 15. The end of the passageway 21 at the one end of the 17 of the body is closed by a removable plug 23. The opening of the central longitudinal passage 21 at the other end of the body 15 is defined by a reduced diameter aperture 25 which is defined by a tubular boss 27 provided at the other end. The central longitudinal passage 21 supports a driving member 29 which is slidably received within the central longitudinal passage 21 and is provided with an extension element 31 which extends through the reduced diameter aperture 25 and beyond the other end of the body 15. A suitable sealing boot 33 is provided between the tubular spigot and the extension 31 to prevent the passage of foreign materials into the junction between the tubular spigot 31 and the extension 31. A biasing spring 35 is located in the central longitudinal passage 21 between the plug 23 and the inner end of the driving member 29 and applies a biasing action to the driving member to cause it to be engaged with the other end of the central longitudinal passage 21.

The body further includes a laterally directed passage 37 which opens to one side of the elongate body. The inner end of the laterally directed passageway 37 is closed and extends beyond the central longitudinal passage 21. A lug member 39 is slidably received within the lateral passage 37 and a sealing boot 41 is provided between the lug 39 and the body 15 to seal the junction therebetween. The lug is formed with a transverse passageway 43 which is received over a shank portion 45 of the driving member 39 whereby the cross section of the shank portion 45 is complementary to the cross section of the transverse passageway 43. As a result the opposed faces of the transverse passageway are slidably engaged with the abutting supporting faces of the shank portion. In addition the axes of the shank portion 45 and the transverse passageway 43 are co-axial and are obliquely offset from the central longitudinal axis of the drive member 29 and the body member 15. The oblique off set of the opposed faces and the supporting faces will cause transverse displacement of the lug within the elongate body with longitudinal displacement of the driver within the elongate body which will result in the movement of the lug between its extended and retracted positions.

As a result of the complementary inter-engagement of the transverse passageway 43 on the shank portion 35 and the oblique orientation of the central axes of the transverse passageway 43 and the shank portion 45 the longitudinal displacement of the driving member 29 within the central longitudinal passage 21 of the elongate member 15 and relative to the lug 39 will cause lateral displacement of the lug 39 relative to the surface of the body 15. On inward displacement of the driving member 29 into the shaft 21 of the body 15 the lug is caused to move laterally inwardly into the body away from the extended position to cause inward movement of the lug 39. The degree of movement of the driving member 29 with respect to the body 15 is determined by the spacing between innermost end of the driving member 15 and the plug 23 provided at the one end 17 of the body. Similarly the degree of lateral movement of the lug 39 is determined by the spacing between the innermost end of the lug 39 and the innermost end of the lateral passageway 37. In addition the angle of the central axis of the transverse passageway 43 of the lug 39 and of the shank portion 45 of the driving member 29 is such that on an inwardly directed force being applied to the lug 39 the frictional forces between the lug 39 and the shank portion 45 will exceed the moment applied to the driving member against the biasing applied to the driving member by the spring 35 and is significantly less than the outwardly directed moment applied to the lug as a result of the outward relative displacement of the driving member.

To effect engagement of a jig onto the work head, the driving members of each locating means are pushed inwardly against the action of the spring 35 to cause the lugs to be retracted into the surface of the elongate bodies. The jig is then located over the locating means and the driving members are caused to move to their extended position which will cause the lugs to move outwardly form the elongate bodies and into engagement with the openings provided in the side faces of the apertures in the jigs. Because of the force applied to the lug by the driving member as a result of the action of the spring the lug will be forced into its outermost position into the opening to ensure appositive engagement therebetween.

It should be appreciated that the scope of the invention need not be limited to the particular scope or application of the embodiment described above.

1. A locating means adapted to be supported from one element for engagement with another element to retain the two elements in engagement with each other, the locating means comprising a lug to be displaceable between an extended position at which it extends from the locating means and a retracted position at which it is located inward of the extended position, a driving member slidably supported from the one element the lug and driver having at least two opposed faces, the other element having an abutment which is intended in use to be engaged by the lug when the lug is in the extended position and the two elements are in engagement with each other in order to retain the elements in said engagement with each other, the opposed faces being configured such that movement of the driving member relative to the lug causes the displacement of the lug.

2. A locating means as claimed at claim 1 wherein the one element comprises an elongate member and the lug is movable away from the elongate member in its movement to the extended position, the elongate member in use to be received within an aperture provided in the other member whereby the abutment surface of the other member comprises a surface axially inward of the aperture which extends laterally from the edge of the opening.

3. A locating means as claimed at claim 2 wherein the aperture has a configuration which is complementary to the cross-section of the elongate member.

4. A locating means as claimed at claim 1 wherein the lug is slidably supported within the elongate body for slidable movement relative to the elongate body along an axis which is substantially transverse to the elongate body.

5. A locating means as claimed at claim 4 wherein the driving member is slidably supported by the elongate body to be movable relative to the elongate body along an axis which is substantially parallel or coincidental with the central axis of the elongate body.

6. A locating means as claimed at claim 5 wherein the lug is formed with a generally transverse passage and the driving member is formed with a shank portion which is slidably received in the transverse passage, said transverse passage having the opposed faces and the shank portion having the supporting surfaces, the opposed faces and the supporting faces being oblique to the central axes of the lug and the elongate member and to the direction of relative movement of the lug and the driving member in the elongate member.

7. A locating means as claimed at claim 9 wherein one end of the driving member extends from the elongate member and is adapted to be engagable to cause the displacement of the driving member relative to the elongate member.

8. A locating means as claimed at claim 1 wherein the driving member is biased to cause the lug to occupy its extended position.

9. (canceled)

10. A supporting arrangement to support a rotary gig which is adapted to support at least one work-piece from a drive head to enable machining of the work-piece wherein at least one locating means of the form described above is supported form the drive head shaft to retain the two elements in engagement with each other and wherein the locating means is of the form as claimed at claim 1 and is intended in use to engage with and support the rotary jig from the drive head.

11. A supporting arrangement as claimed at claim 10 wherein the one element comprises an elongate member and the lug is movable away from the elongate member in its movement to the extended position, the elongate member in use to be received within an aperture provided in the other member whereby the abutment surface of the other member comprises a surface axially inward of the aperture which extends laterally from the edge of the opening.

12. A supporting arrangement as claimed at claim 11 wherein aperture has a configuration which is complementary to the cross-section of the elongate member.

13. A supporting arrangement as claimed at claim 11 wherein the lug is slidably supported within the elongate body for slidable movement relative to the elongate body along an axis which is substantially transverse to the elongate body.

14. A supporting arrangement as claimed at claim 13 wherein the driving member is slidably supported by the elongate body to be movable relative to the elongate body along an axis which is substantially parallel or coincidental with the central axis of the elongate body.

15. A supporting arrangement as claimed at claim 14 wherein the lug is formed with a generally transverse passage and the driving member is formed with a shank portion which is slidably received in the transverse passage, said transverse passage having the opposed faces and the shank portion having the supporting surfaces, the opposed faces and the supporting faces being oblique to the central axes of the lug and the elongate member and to the direction of relative movement of the lug and the driving member in the elongate member.

16. A supporting arrangement as claimed at claim 15 wherein one end of the driving member extends from the elongate member and is adapted to be engagable to cause the displacement of the driving member relative to the elongate member.

17. A supporting arrangement as claimed at claim 11 wherein the driving member is biased to cause the lug to occupy its extended position.

18. (canceled)
